(19) United States
(12) Patent Application Publication
(10) Pub. No.: US 2023/0107301 A1
(43) Pub. Date: Apr. 6, 2023

(54) METHOD FOR DYNAMIC LEADER SELECTION FOR DISTRIBUTED MACHINE LEARNING

(71) Applicant: Telefonaktiebolaget LM Ericsson (publ), Stockholm (SE)

(72) Inventors: Farnaz Moradi, STOCKHOLM (SE); Erik Sanders, Vallentuna (SE); Yang Zuo, LULEÅ (SE); Rafia Inam, VÄSTERÅS (SE)

(21) Appl. No.: 17/766,798

(22) PCT Filed: Oct. 15, 2019
(86) PCT No.: PCT/EP2019/077901

§ 371 Date: Apr. 6, 2022

(51) Int. Cl. G06N 20/00

(52) U.S. Cl. CPC G06N 20/00

(57) ABSTRACT

A method by a computing device for dynamically configuring a network comprising a plurality of computing devices configured to perform training of a machine learning model is provided. The method includes dynamically identifying a change in a state of a leader computing device, wherein the leader computing device includes one of a server computing device and a client computing device and wherein the plurality of computing devices include server computing devices and/or client computing devices. The method further includes determining whether the change in the state triggers a new leader computing device to be selected. The method further includes initiating a new leader election among the plurality of computing devices responsive to determining the change in the state triggers the new leader computing device to be selected. The method further includes receiving an identification of the new leader computing device based on the initiating of the new leader election.

### TECHNICAL FIELD

The present disclosure relates generally to communications, and more particularly to a method, a computing device for dynamically configuring a network comprising a plurality of computing devices configured to perform training of a machine learning model.

### BACKGROUND

In federated learning (FL) [1], a centralized server, known as master, is responsible for maintaining a global model which is created by aggregating the models/weights which are trained in an iterative process at participating nodes/clients, known as workers, using local data.

FL depends on continuous participation of workers in an iterative process for training of the model and communicating the model weights with the master. The master can communicate with different number of workers ranging between tens to millions, and the size of model weight updates which are communicated can range between kilobytes to tens of megabytes [3]. Therefore, the communication with the master can become a main bottleneck.

When the communication bandwidth is limited or is unreliable, the latencies may increase which can slow down the convergence of the model training. If any of the workers becomes unavailable during federated training, the training process can continue with the remaining workers. Once the worker becomes available it can re-join the learning by receiving the latest version of the weights of the global model from the master. However, if the master becomes unavailable the training process is stopped completely.

### SUMMARY

According to some embodiments of inventive concepts, a method is provided for dynamically configuring a network comprising a plurality of computing devices configured to perform training of a machine learning model, the method performed by a computing device communicatively coupled to the network. The method includes dynamically identifying a change in a state of a leader computing device, wherein the leader computing device comprises one of a server computing device and a client computing device and wherein the plurality of computing devices comprise server computing devices and/or client computing devices. The method further includes determining whether the change in the state of the leader computing device requires a new leader computing device to be selected. The method further includes initiating a new leader node election among the plurality of computing devices responsive to determining the change in the state of the leader computing device triggers the new leader computing device to be selected. The method further includes receiving an identification of the new leader computing device based on the initiating of the new leader election.

One potential advantage is enabling to dynamically identify/predict issues that can impact the leader computing device (e.g. a master node) of a machine learning model and selecting a new leader computing device at run-time to ensure fast and reliable convergence of machine learning. Other advantages that may be achieved is dynamically selecting/changing a leader computing device among different devices (e.g., eNodeB/gNB) based on local resource status and using distributed leader election during run time in case of any failure or high load situations, etc.

According to other embodiments of inventive concepts, a method performed by a computing device in a plurality of computing devices for selecting a new leader computing device for operationally controlling a machine learning model in a telecommunications network is provided. The method includes dynamically identifying a change in a state of a leader computing device among the plurality of computing devices. The method further includes determining whether the change in the state of the leader computing device triggers a new leader computing device to be selected. The method further includes initiating a new leader election among the plurality of computing devices responsive to determining the change in the state of the leader computing device triggers a new leader computing device to be selected. The method further includes receiving an identification of the new leader computing device based on the initiating of the new leader election.

According to yet other embodiments of inventive concepts, a computing device in a network comprising a plurality of computing devices configured to perform training of a machine learning model is provided. The computing device is adapted to perform operations including dynamically identifying a change in a state of a leader computing device, wherein the leader computing device comprises one of a server computing device and a client computing device and wherein the plurality of computing devices comprise server computing devices and/or client computing devices. The computing device is adapted to perform further operations including determining whether the change in the state of the leader computing device triggers a new leader computing device to be selected. The computing device is adapted to perform further operations including initiating a new leader election among the plurality of computing devices responsive to determining the change in the state of the leader computing device triggers a new leader computing device to be selected. The computing device is adapted to perform further operations including receiving an identification of the new leader computing device based on the initiating of the new leader election.

According to yet other embodiments of inventive concepts, a computer program comprising computer program code to be executed by processing circuitry of a computing device configured to operation a communication network is provided whereby execution of the program code causes the computing device to perform operations including dynamically identifying a change in a state of a leader computing device, wherein the leader computing device comprises one of a server computing device and a client computing device and wherein the plurality of computing devices comprise server computing devices and/or client computing devices. The operations further include determining whether the change in the state of the leader computing device triggers a new leader computing device to be selected. The operations further include initiating a new leader election among the plurality of computing devices responsive to determining the change in the state of the leader computing device triggers a new leader computing device to be selected. The operations further include receiving an identification of the new leader computing device based on the initiating of the new leader election.

According to yet other embodiments of inventive concepts, a computer program product comprising a non-transitory storage medium including program code to be executed by processing circuitry of a computing device configured to operate in a communication network is provided, whereby execution of the program code causes the computing device to perform operations including dynamically identifying a change in a state of a leader computing device, wherein the leader computing device comprises one of a server computing device and a client computing device and wherein the plurality of computing devices comprise server computing devices and/or client computing devices. The operations further include determining whether the change in the state of the leader computing device triggers a new leader computing device to be selected. The operations further include initiating a new leader election among the plurality of computing devices responsive to determining the change in the state of the leader computing device triggers a new leader computing device to be selected. The operations further include receiving an identification of the new leader computing device based on the initiating of the new leader election.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a telecommunications environment illustrating devices that may perform tasks of a master node and/or a worker node according to some embodiments of inventive concepts;

FIG. 2 is a signaling diagram illustrating operations to change in the master node/leader computing device according to some embodiments of inventive concepts;

FIG. 3 is a signaling diagram illustrating operations to change in the master node/leader computing device according to some embodiments of inventive concepts;

FIG. 4 is an illustration of a list of worker nodes/non-leader computing devices and a master node/leader computing device before a change in the master node according to some embodiments of inventive concepts;

FIG. 5 is an illustration of a list of worker nodes/non-leader computing devices and a master node/leader computing device after a change in the master node according to some embodiments of inventive concepts;

FIG. 6 is a block diagram illustrating a distributed ledger according to some embodiments of inventive concepts;

FIG. 7 is an illustration of a list of worker nodes/non-leader computing devices and a list of master nodes/leader computing devices before a change in the master node/leader computing device according to some embodiments of inventive concepts;

FIG. 8 is an illustration of a list of worker nodes/non-leader computing devices and master nodes/leader computing devices after a change in the master node/leader computing device according to some embodiments of inventive concepts;

FIG. 9 is a block diagram illustrating a worker node/non-leader device according to some embodiments of inventive concepts;

FIG. 10 is a block diagram illustrating a master node/leader computing device according to some embodiments of inventive concepts;

FIGS. 11a-15 are flow charts illustrating operations of a master node/leader computing device and/or a worker node/non-leader computing device according to some embodiments of inventive concepts;

FIG. 16 is a block diagram of a wireless network in accordance with some embodiments; and

FIG. 17 is a block diagram of a user equipment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As previously indicated, in existing FL solutions, the master/server is assumed to run in a reliable server or datacenter with no resource constraints. In [3], a scalable distributed learning system is presented where ephemeral actors may be spawned when needed and failure of different actors in the system are handled by restarting them. In[3] the workers are mobile phones which cannot act as a master. The implementation of the inventive concepts described herein of the machine learning model avoids the issues with the Master being the single point of failure, however it assumes that a reliable datacenter environment is available with enough resources to spawn ephemeral actors when needed.

If the master does not run on a reliable datacenter environment, it becomes a single point of failure. E.g. if the master is an eNB/gNB node then it may not have a redundant HW/SW. Further this master may experience any issues such as power outage, high overhead, low bandwidth, bad environmental conditions, etc. From all these factors, the convergence of the learning process can get affected. This is particularly problematic for use-cases which require continuous update of the machine learning (ML) models, e.g., online learning, where delays in model convergence could adversely affect the performance of the use-case.

For massive Machine Type Communication (mMTC) and critical Machine Type Communication (cMTC) cases where the latency requirements may be very strict and there is a need to update the model while meeting the latency requirements, keeping the master node at the data center could be time critical. Therefore, the master node should be kept closer to the worker nodes, particularly for cases when online learning is needed, and the model has to be continuously re-trained using new data while satisfying latency requirements. An example of this is Vehicle to Vehicle communication for enabling ultra-reliable and low-latency vehicular communication by having the master node reside at the roadside units (RSUs) or eNodeBs (eNBs).

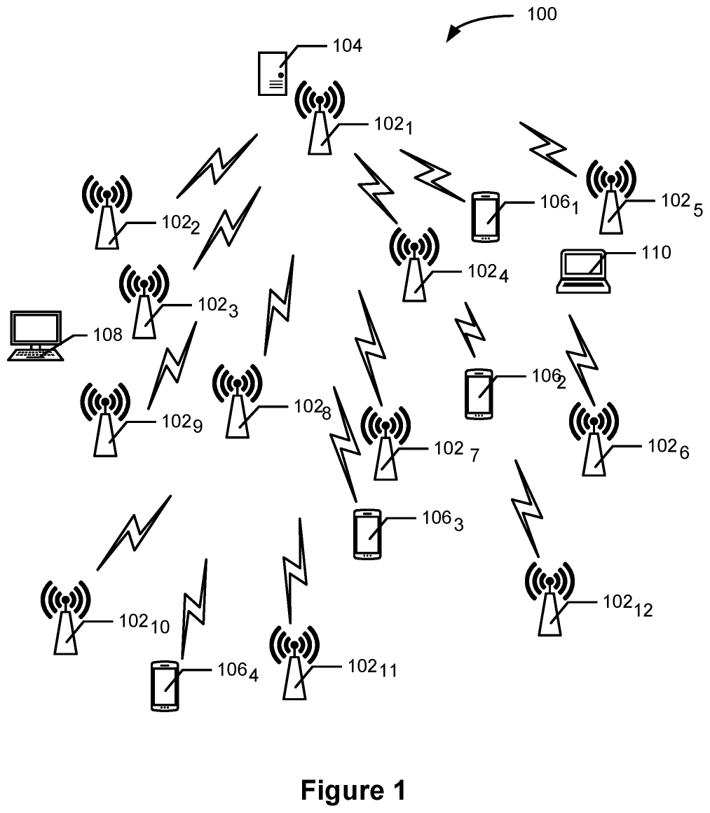

FIG. 1 is a diagram illustrating an exemplary operating environment 100 where the inventive concepts described herein may be used. In FIG. 1, nodes 102₁ to 102₁₂, such as eNodeBs, gNBs, etc., core network node 104, mobile devices 106₁ to 106₄, device 108, which may be referred to as a desktop device, server, etc., and portable device 110 such as a laptop, PDA, etc. are part of the operating environment 100. Any of the nodes 102, core network node 104, mobile devices 106, device 108, and portable device 110 may perform the role of a worker node (i.e., non-leader computing device) and/or a master node (i.e., a leader computing device) as described herein.

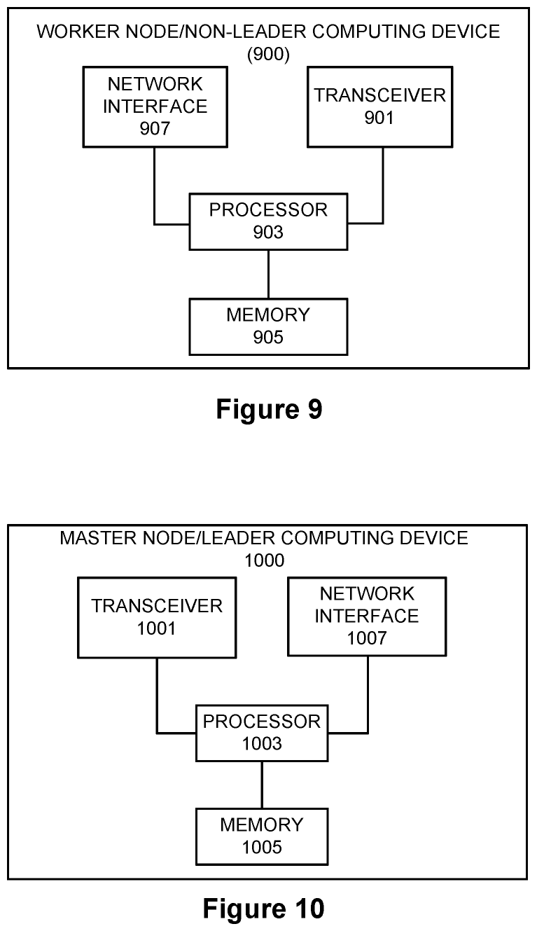

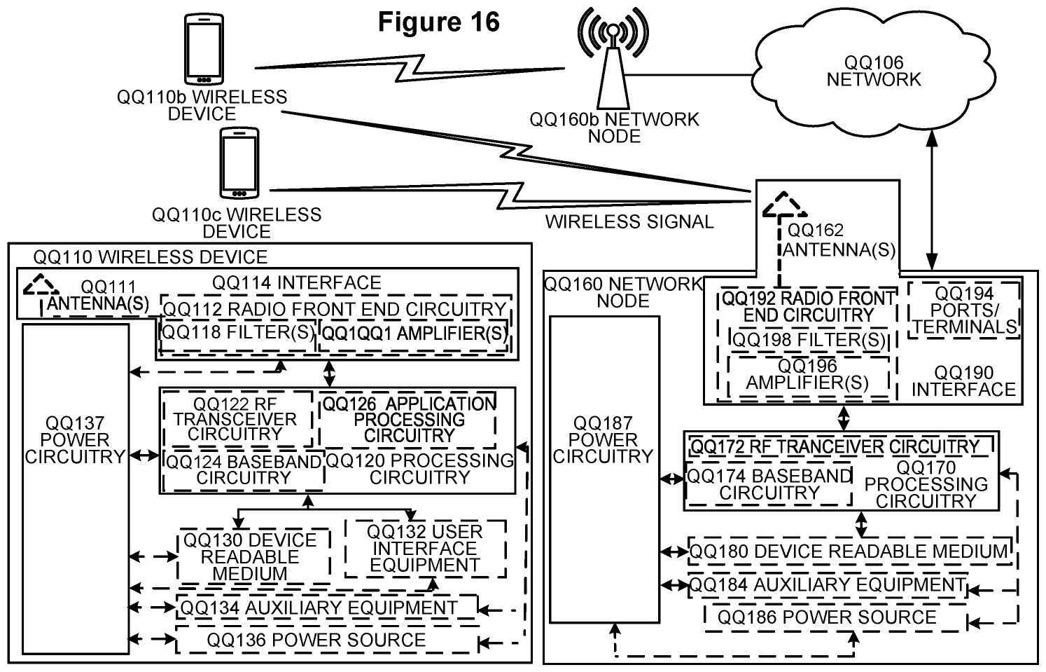

FIG. 9 is a block diagram illustrating elements of a worker node 900, also referred to as a client computing device, a server computing device, a non-leader computing device, a user equipment (UE), etc. (and can be referred to as a terminal, a communication terminal, mobile terminal, a mobile communication terminal, a wired or wireless communication device, a wireless terminal, a wireless communication terminal, a network device, a network node, a desktop device, a laptop, a base station, eNodeB/eNB, gNodeB/gNB, a worker node/terminal/device, etc.) configured to provide communications according to embodiments of inventive concepts. Thus a worker node/non-leader computing device 900 may be a client computing device or a server computing device as either of a client computing device or a server computing device may be a worker node/non-leader computing device 900. (Worker node 900 may be provided, for example, as discussed below with respect to wireless device QQ110 or network node QQ160 of FIG. 16 when in a wireless telecommunications environment.) As shown, worker node 900 may include transceiver circuitry 901 (also referred to as a transceiver, e.g., corresponding to interface QQ114 or RF transceiver circuitry QQ172 when in a wireless telecommunications environment of FIG. 16) including a transmitter and a receiver configured to provide uplink and downlink radio communications or wired communications with a master node 1000. Worker node 900 may also include processing circuitry 903 (also referred to as a processor, e.g., corresponding to processing circuitry QQ120 or processing circuitry QQ170 of FIG. 16 when used in a telecommunications environment) coupled to the transceiver circuitry, and memory circuitry 905 coupled to the processing circuitry. The memory circuitry 905 may include computer readable program code that when executed by the processing circuitry 903 causes the processing circuitry to perform operations according to embodiments disclosed herein. According to other embodiments, processing circuitry 903 may be defined to include memory so that separate memory circuitry is not required. Worker node 900 may also include an interface (such as a user interface) 907 coupled with processing circuitry 903, and/or worker node may be incorporated in a vehicle.

As discussed herein, operations of worker node 900 may be performed by processing circuitry 903 and/or transceiver circuitry 901 and/or network interface 707. For example, processing circuitry 903 may control transceiver circuitry 901 to transmit communications through transceiver circuitry 901 over a radio interface to a master node and/or to receive communications through transceiver circuitry 901 from a master node and/or another worker node over a radio interface. Processing circuitry 903 may control network interface circuitry 907 to transmit communications through a wired interface to a master node and/or to receive communications from a master node and/or another worker node over the wired interface. Moreover, modules may be stored in memory circuitry 905, and these modules may provide instructions so that when instructions of a module are executed by processing circuitry 903, processing circuitry 903 performs respective operations discussed below with respect to embodiments relating to worker node 900). In the description that follows, worker node 900 may be referred to as a worker, a worker device, a worker node, or a non-leader computing device.

FIG. 10 is a block diagram illustrating elements of a master node 1000, also referred to as a client computing device, a server computing device, a leader computing device, a user equipment (UE), etc. (and can be referred to as a terminal, a communication terminal, mobile terminal, a mobile communication terminal, a wired or wireless communication device, a wireless terminal, a wireless communication terminal, a desktop device, a laptop, a network node, a base station, eNodeB/eNB, gNodeB/gNB, a master node/terminal/device, a leader node/terminal/device, etc.) configured to provide cellular communication or wired communication according to embodiments of inventive concepts. Thus a master node/leader computing device 900 may be a client computing device or a server computing device as either of a client computing device or a server computing device may be a master node/leader computing device 1000. In some embodiments, a server computing device or a client computing device may be a master node 1000 for a machine learning model and also be a worker node 900 for a different machine learning model. (Master node 1000 may be provided, for example, as discussed below with respect to network node QQ160 or wireless device QQ110 of FIG. 16 when used in a telecommunications network.) As shown, the master node may include transceiver circuitry 1001 (also referred to as a transceiver, e.g., corresponding to portions of interface QQ190 or interface QQ114 of FIG. 16 when used in a telecommunications network) including a transmitter and a receiver configured to provide uplink and downlink radio communications with mobile terminals. The master node 1000 may include network interface circuitry 1007 (also referred to as a network interface, e.g., corresponding to portions of interface QQ190 or interface QQ114 of FIG. 16 when used in a telecommunications network) configured to provide communications with other nodes (e.g., with other master nodes and/or worker nodes). The master node 1000 may also include a processing circuitry 1003 (also referred to as a processor, e.g., corresponding to processing circuitry QQ170 or processing circuitry QQ120 of FIG. 16 when used in a telecommunications network) coupled to the transceiver circuitry and network interface circuitry, and a memory circuitry 1005 (also referred to as memory, e.g., corresponding to device readable medium QQ180 or QQ130 of FIG. 16) coupled to the processing circuitry. The memory circuitry 1005 may include computer readable program code that when executed by the processing circuitry 1003 causes the processing circuitry to perform operations according to embodiments disclosed herein. According to other embodiments, processing circuitry 1003 may be defined to include memory so that a separate memory circuitry is not required.

As discussed herein, operations of the master node 1000 may be performed by processing circuitry 1003, network interface 1007, and/or transceiver 1001. For example, processing circuitry 1003 may control transceiver 1001 to transmit downlink communications through transceiver 1001 over a radio interface to one or more worker nodes and/or to receive uplink communications through transceiver 1001 from one or more worker nodes over a radio interface. Similarly, processing circuitry 1003 may control network interface 1007 to transmit communications through network interface 1007 to one or more other master nodes and/or to receive communications through network interface from one or more other network nodes and/or devices. Moreover, modules may be stored in memory 1005, and these modules may provide instructions so that when instructions of a module are executed by processing circuitry 1003, processing circuitry 1003 performs respective operations (e.g., operations discussed below with respect to embodiments relating to master nodes).

One advantage that may be realized by the inventive concepts described herein is the automatic selection of a master node (i.e., leader computing device) to avoid issues such as single point of failure and failure to meet requirements (e.g., overload situations, etc.). Another advantage that may be realized by the inventive concepts described herein is the timely convergence of a machine learning model without any delays caused by a master node's failure/overload.

Additionally, privacy may be improved for vendors who do not want to share their model or resource status with other vendors. Furthermore, the dynamic master node selection described herein may be useful for mMTC and cMTC use cases where short latencies are needed for the closed loop operations. The dynamic master node selection described herein may also be useful for ultra-reliable low latency communications (URLLC) use cases.

Described below are embodiments that may dynamically select/change a master node among different devices (e.g., eNodeB/gNB, UE, etc.), based on local resource status and using a distributed leader election during run time in case of any failure or high load situations, etc. In the description that follows, a master node may also be referred to as a leader computing device. Additionally, a worker node may also be referred to as a non-leader computing device.

In one embodiment, one of the participating nodes in the distributed learning system can act both as a worker node in a machine learning model and the master node in another machine learning model or as both a worker node and a master node in a single machine learning model. As an example, in the telecommunications domain, a group of eNodeBs/eNB/gNB (gNB in 5G) in a geographical region can form a group, such as a federated group, to train an ML model. In this case, one of the eNodeBs/gNB in addition to participating in the group as a worker node, can take the role of the master node. The master node may be responsible for collecting, aggregating, and maintaining the model for the geographical region.

An embodiment for selecting a master node among different nodes (e.g., eNodeB/gNB, UEs, etc.) shall now be described.

For a ML model to be trained using distributed learning such as federated learning, each node of the different types of nodes may compute the capacity of the node, measure the node load, monitor power usage of the node, etc. The information should remain local to the node and may not be shared with other nodes. Each node uses the information (e.g., capacity of node, node load, power usage, etc.) to decide locally whether the node will participate in a distributed learning round and/or a leader election.

Master Node Selection

The different nodes may select the master node 1000 using a leader election/selection methodology where all the participating nodes of the different nodes reach a consensus and select one of the nodes as the master node.

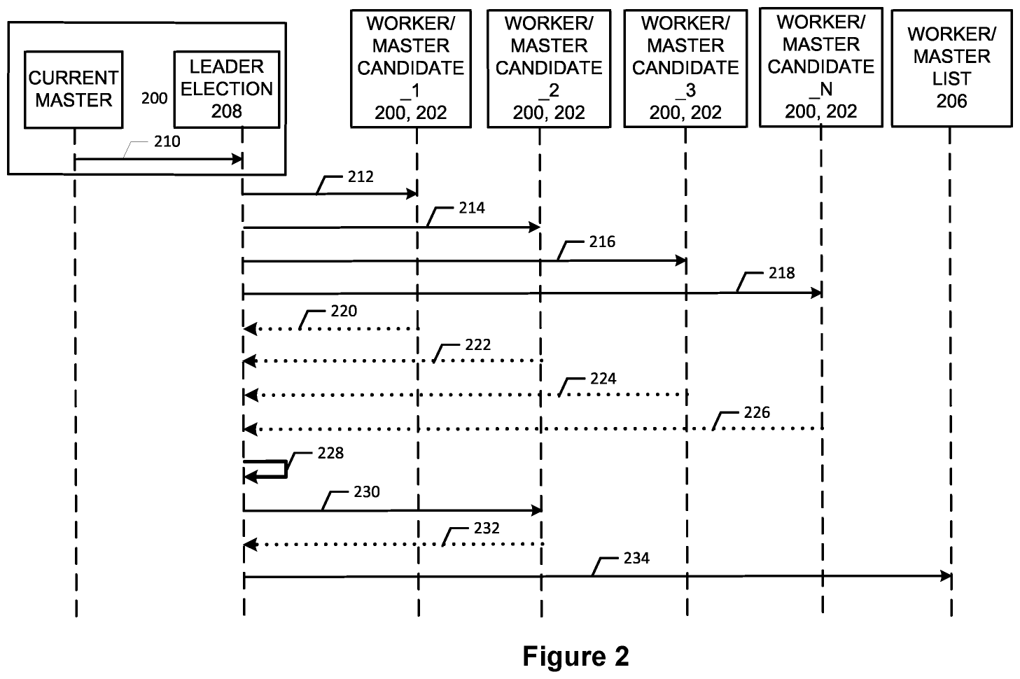

Turning to FIG. 2, the node selected as the master node may initiate the machine learning model by communicating with all participating worker nodes and exchanging model weights, aggregating them, and communicating the updated machine learning model (e.g., global model) to the worker nodes. The master node can also participate as a worker node by training the machine learning model on the master node's local data.

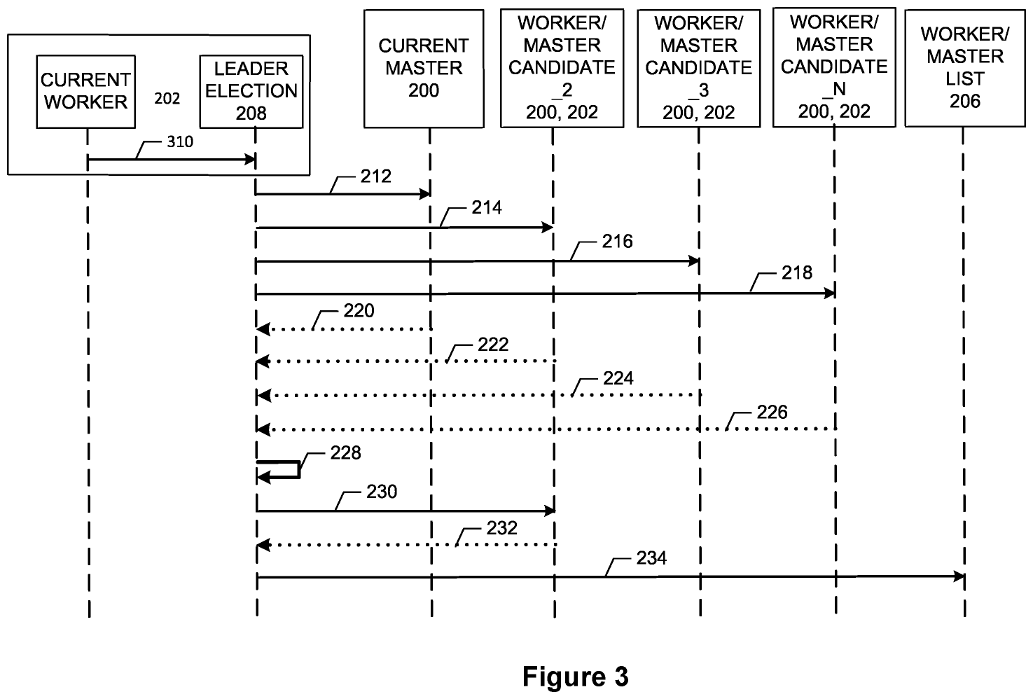

A change in the state (e.g., status) of the master node performance may be dynamically identified. The change may be event based, pre-scheduled, or predicted based on monitored status of the master node. For example, the master node, which locally monitors its own condition and resource status can detect or predict (using ML) that it will face resource issues and notify other nodes that it has to withdraw from the master role (e.g., can no longer be a master node). This is indicated by operation 210 where the master node provides a request to leader election module 208 that is part of the master node. Alternatively, a worker node can detect that the master node is unresponsive and inform other worker nodes via the leader election module that is part of the worker node. This is indicated by operation 310 of FIG. 3.

If the identified change in the master node performance can affect the performance of the distributed learning, a new leader election round may be initiated by the leader election. This is indicated by operations 212 to 218 in FIGS. 2 and 3 by the transmittal of a request leader candidate message to each candidate 200, 202. In the embodiment of FIG. 3, the leader election is run by the candidate node that detected that the leader node is not available. Each candidate 200, 202, which may be a master node 200 or a worker node 202, responds to the request leader candidate message with a rejection to be the leader or volunteer to be the leader. The responses to the request leader candidate are shown by operations 220-226. At operation 228, the leader module in the current master 200 (or the current worker 202 in FIG. 3) selects the new master node and transmits a request to the selected new master node in operation 230 to take the leader role. The new master replies with an acceptance (or a rejection) of the leader role in operation 232. Generally, one of the worker nodes 202 is elected as the new master. However, in some embodiments, the current master 200 may be elected to be the new master node 200. For example, if power that was out at the site where the current master 200 is located is restored, the current master 200 may be elected to be the new master node 200. The current master node may communicate the list of worker nodes and the latest model weights to the new master node. Other techniques to select the new leader are described below.

Upon each change of master nodes, information about the “old” master node and “old” worker nodes and the newly chosen master node and its “new” worker nodes may be stored in the system for record keeping and transparency into e.g., a distributed ledger in operation 234. Some of the old worker nodes or all of the old worker nodes may become the new worker nodes.

Each node can participate in training different ML models for different use cases. For each ML model which is trained using distributed learning, a master node and a number of worker nodes collaborate with each other. A computing device can have both a master role (i.e., be a master node) and worker roles (e.g., be a worker node) at the same time for different ML models. All participants in a ML model may have to know the master node and other worker nodes for the ML model which they are training. When the training for a new use case starts, a master node may be elected for the new use case.

The state of the master node may be continuously monitored locally, e.g., latency, load, power usage to dynamically identify a change in the state of the leader computing device. The monitoring information in one embodiment is not shared with other nodes such as other master nodes and worker nodes. A predictive model can be used to predict if/when the performance of the master node will be degraded. If such degradation is detected locally by the master node, a new round of leader election may be initiated by sending a leader election initialization message to all the worker nodes in the distributed learning system. After leader election, the previous master node either changes its role to be a worker role or withdraws from participating in the distributed learning system. The previous master node sends the latest global model as well as list of participating worker nodes to the newly elected master node.

Master Node Failure

If the master node becomes unavailable, a new round of leader election may be initiated. The leader election can be initiated by any of the worker nodes which identifies the issue, e.g., failed attempt to send model weights to the master node, or a timeout when waiting for receiving the aggregated model weights.

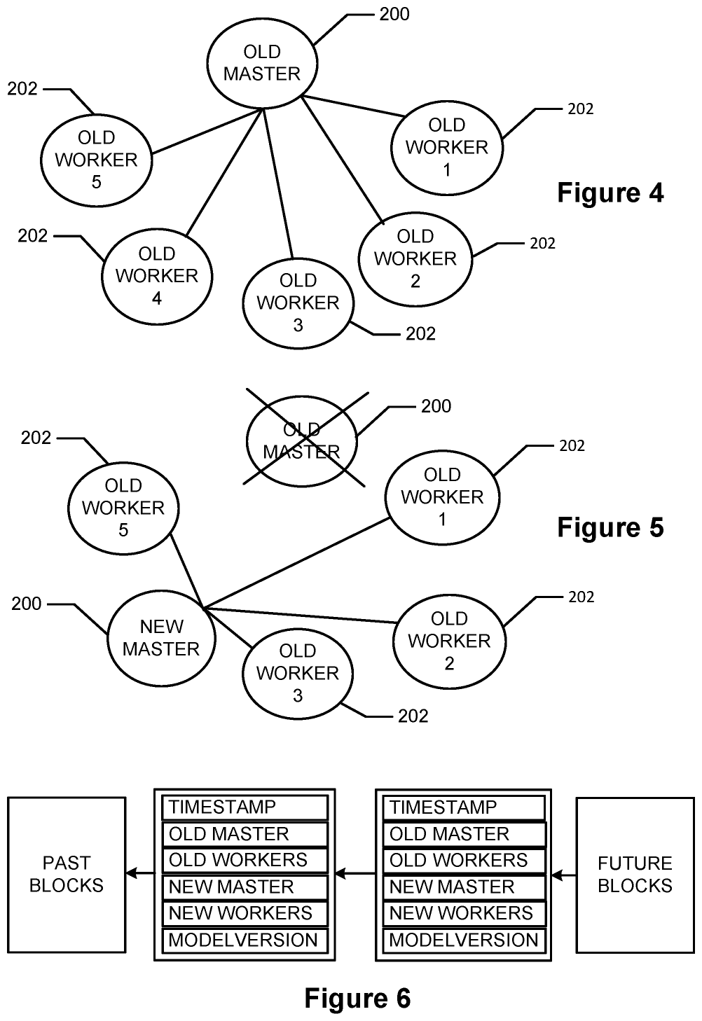

When a new master node is elected, the new master node will receive the latest version of the machine learning model (e.g., global model(s)) from the former master node. However, if the former master node is unavailable (e.g., power outage), then the new master node may request the latest version of the global model from one or more of the participating worker nodes. The new master node then identifies the latest model and distributes it to all the worker nodes before resuming the distributed learning process. FIG. 4 illustrates one form of a list of worker nodes 202 and the master node 200 before changing of the master node. FIG. 5 illustrates a change in a master node 200 when a previous worker node 202 (e.g., worker node 4) became the new master node 200.

If a master node became unavailable before sending the latest aggregated model to any of the worker nodes, then one round of distributed learning training may be repeated at all the worker nodes. This will not impact the model performance since the model training is an iterative process and not all worker nodes have to participate in all rounds of training. In an alternative embodiment, the worker nodes may re-send their latest local weights to the new master node, which then computes the aggregated global model. In this alternative embodiment, no extra round of training is needed.

Leader Election

Different techniques may be used for a distributed leader election.

One embodiment of a leader election is for a node to volunteer to become the leader/master node for distributed learning of a specific model based on the node's situation (e.g., low overhead). In this case this decision must be communicated with all the participating worker nodes. If multiple nodes volunteer at the same time, a tie breaking strategy should be used, e.g., node with the highest identifier (e.g., IP address, etc.).

Another leader election embodiment that may be used is a Bully algorithm. In this embodiment, all nodes know the ID of the other nodes. A node can initiate leader election by sending a message to all nodes with higher IDs and waiting for their response. If no response is received, the node sending the message declares itself as the leader (i.e., master node). If a response from the higher ID nodes is received, the node drops out of leader election and waits for the new master node to be elected.

An example of the Bully algorithm shall be described using FIGS. 4 and 5. Turing to FIG. 5, the worker node 3 detects that the current master node is unavailable and decides to initiate a leader election (e.g., operation 310). The worker node 3 sends a message to worker nodes 4 and 5 (e.g., operations 212-218 of FIG. 3). The worker node 4 sends a response back to worker node 3, so worker node 3 may quit the leader election in response to receiving the response. The worker node 4 re-initiates leader election by sending a message to worker node 5. The worker node 5 does not respond in a pre-determined amount of time (e.g. the worker node 5 decides locally that it does not have enough resources). The worker node 4 then becomes the leader (i.e., new master node) and will inform the lower ID worker nodes 1, 2, and 3. The new listing is illustrated in FIG. 5 where the worker node 4 becomes the new master node 200 and the old worker nodes 1, 2, 3, and 5 become the worker nodes 202 for the new master node 200.

Another embodiment of leader election is in a network with a logical Ring topology. In this embodiment, a node can initiate leader election and send a message containing the node's own ID in a specified direction (e.g., clock wise). Each node adds its own ID and forwards the message to the next node in the ring. Each node ID may be a unique ID in the logical Ring topology. When the message comes back to the initiating node and the initiating node's ID is the highest ID in the list, then the initiating node becomes the leader (i.e., becomes the master node). If another node has the highest ID, the initiating node may send the list to that node for that node to become the new master node.

There are different distributed leader election algorithms available in the literature. An example of such algorithms may be found in [2].

### EXAMPLES

The embodiments described above can be beneficial in different scenarios where the state of the system (e.g., system status) can dynamically change. An example of a change is system status is a power outage in a site where the eNodeB/gNB is forced to use battery. In this case, in order to reduce energy consumption, the node should not remain the master node or even participate as a worker node until the power issue is resolved. A master node can also become unavailable due to power outage at a site without battery backup, which should re-enforce a new round of leader election as described above.

Another example where a change may occur is where an eNodeB/gNB located in an industrial area and the eNodeB/gNB is overloaded during working hours but can take the master role during night or weekends. In such cases, performance counters and/or key performance indicators can be used to detect a pattern of when the eNodeB/gNB is overloaded and when the eNodeB/gNB is available. For example, based on the pattern detected, an eNodeB/gNB that is performing the role of a master node can predict that the eNodeB/gNB will become overloaded starting near the beginning of working hours and send the request 210 to change the leader before the start of working hours.

Another example where the inventive concepts described herein may be used is in cMTC communications. The cMTC communication may be needed in robotics field such as on factory floors, logistics warehouses, etc. where high computations are required to execute the AI/ML models at the devices (robots). And due to limited resources, the inventive concepts described herein may be executed at hardware having high processing capacity close by (like GPUs, etc.). This processing unit may be physically placed close by to meet the very low latency requirements of the robots. Each floor in the factory may have its own processing unit connected to the robots of that floor. Each of the processing units can be a worker node and be part of distributed learning. When the processing unit of a floor predicts that overload will be happening, the processing unit may initiate the request 201 to change leader. A measurement procedure may be provided for the purpose of monitoring data rate, latency and other factors on which the request may be based upon. For example, performance counters and/or key performance indicators (KPI, e.g., a latency KPI, a throughput KPI, a reliability KPI, etc.) Each KPI has its own threshold value and can be based on a different set of performance counters from other KPIs. This example also applies to massive machine type communication (mMTC).

Another example where the inventive concepts described herein may be used to dynamically group eNodeB/gNB is when events occur such as detection of a software anomaly at a node. For example, if the software version of the current master or any of the worker nodes gets updated, then the node that is updated should not participate in the federation when operation of the node has changed (e.g., the pattern is not valid anymore). Thus, there can be a need to elect a new master node and group the worker nodes at different software levels, as software updates can be different and happen at different times.

Another example of where the inventive concepts described herein may be used is in vehicles, such as self-driving vehicles where road conditions for a defined geographical area are shared between vehicles in the area. One of the vehicles in the defined geographic area is selected as a leader as described above. The leader performs the role of a master node for the road conditions while the vehicle selected as the leader remains in the area. When the leader is predicted to leave the area, a new leader selection is performed as described above. The leader sends the information it has to the new leader. This cycle may be repeated for as long as needed.

Extensions

An example of the information stored in a distributed ledger (e.g., a block chain) is illustrated in FIG. 6. In each block of FIG. 6, there are six boxes. The first box stores the date and time at when a new leader (i.e., new master node) is decided. The second and third boxes contains the identification of the old master node and a list of old worker nodes respectively, while the fourth and fifth boxes contain the identification of the newly elected master node and a new list of worker nodes. The new list of worker nodes may be different than the old list of worker nodes because the old master node may become a worker node in the new list, and one of the old worker nodes maybe a master node and removed from the list of worker nodes. Thus, it may be important to keep track of the master node and worker nodes at each change. The sixth box lists the model version.

Since the number of worker nodes and the master node can change frequently, it may be important that the system stores all information about the worker nodes and the master nodes especially whenever a change is made (e.g., a new master is chosen). A distributed ledger is one way to store the information.

Each node may keep a copy of the distributed ledger. Whenever a new master node is chosen, an entry will be added to the ledger and this new entry will be circulated to all the nodes (master node and worker nodes) so that each node's local ledger copy is updated. Keeping only one copy of the ledger in the system in the master node should not be done because when the master node is down (e.g. due to failure or power outage) the ledger information will not be available. Thus, each node may keep a local copy of the ledger. Alternatively, the ledger can be kept in a centralized datacenter from where it can be retrieved when needed.

One advantage of using a ledger is to keep the updated system state (who is the current master node and the list of all worker nodes) and to confirm trustability/transparency of a model to be maintained in the system.

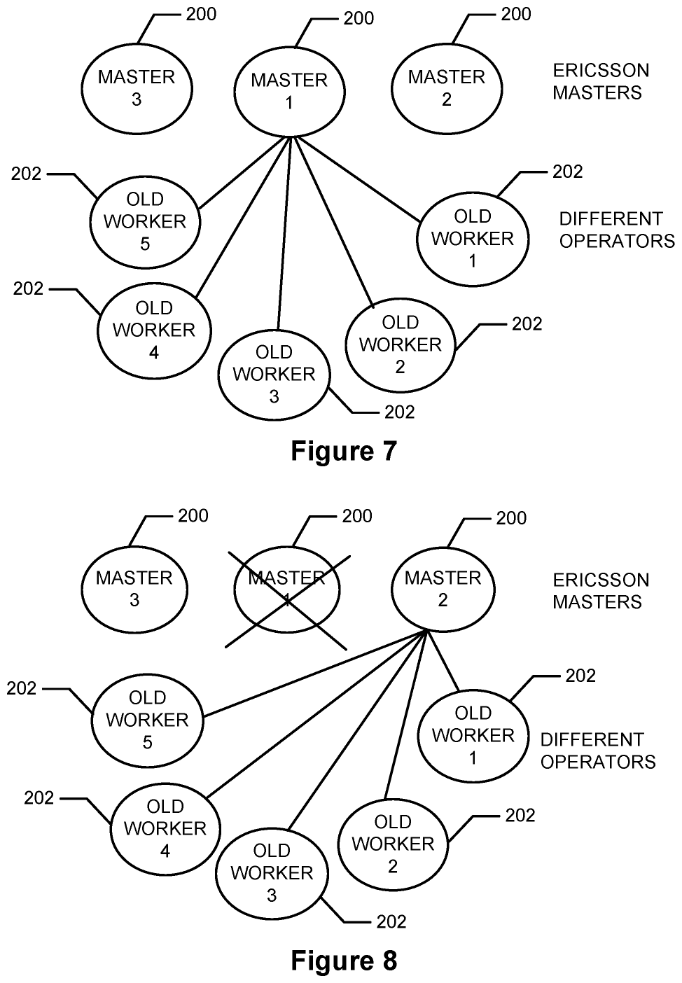

Turning to FIGS. 7 and 8, an embodiment is illustrated where a list of master nodes 200 is kept that serves different worker nodes. This means that a worker node 202 in this embodiment cannot be chosen as a master node 200. In this case, when a master node 200 initiates a change (e.g., master node 1 in FIG. 7), another master node 200 is chosen only from the dedicated list of master nodes 200 and the worker nodes 202 are assigned to the newly chosen master node. This is illustrated in FIG. 8 where the old worker nodes 1-5 are assigned to the new master node 2. The leader election (e.g., as described above) will be done only among master nodes in this embodiment. Thus, in these embodiments, the worker/master candidates 200, 202 in FIG. 2 must all be master nodes 200. In this embodiment, the ledger may be kept only among the master nodes as the worker nodes do not need to keep a copy of the ledger since the worker nodes will not become a master node.

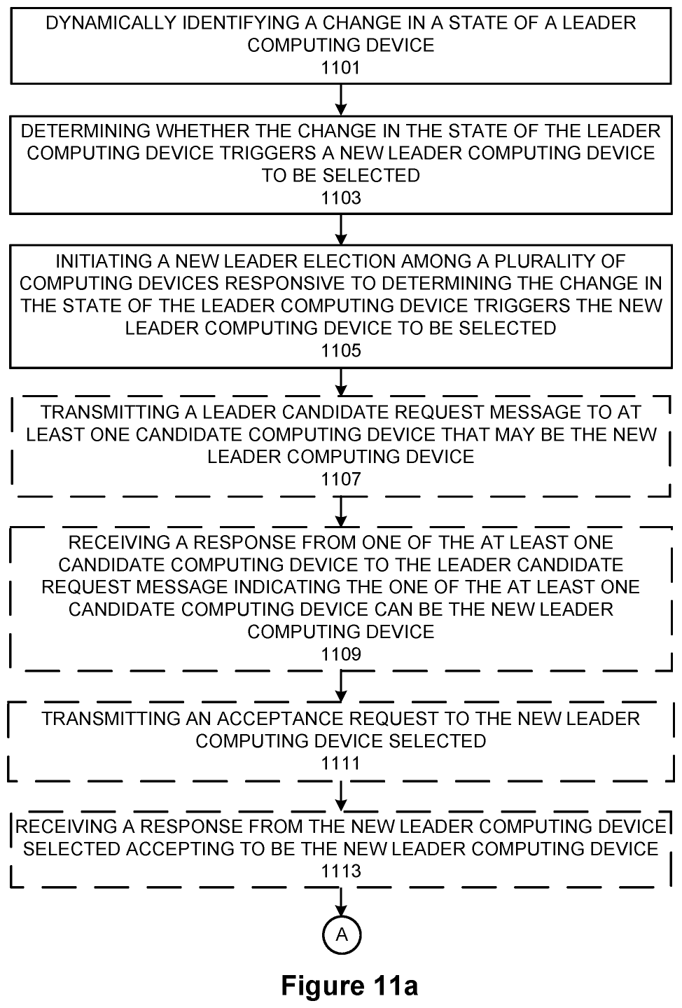

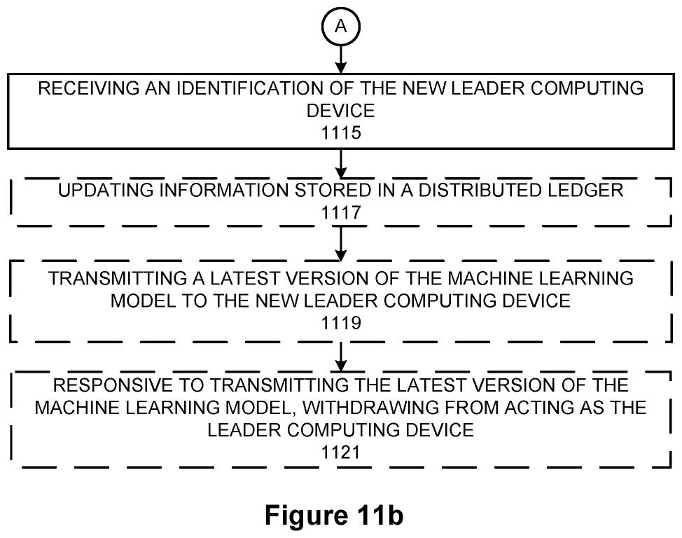

Operations of the worker node 900 (i.e., non-leader computing device 900, server computing device 900, client computing device 900) and/or the master node 110 (i.e., leader computing device 1000, server computing device 1000, client computing device 1000) implemented using the structure of the block diagram of FIG. 9 and/or FIG. 10, respectively, will now be discussed with reference to the flow chart of FIG. 11 according to some embodiments of inventive concepts. For example, modules may be stored in memory 905 of FIG. 9 (or memory 1005 of FIG. 10), and these modules may provide instructions so that when the instructions of a module are executed by respective worker node processing circuitry 903 (or master node processing circuitry 1003), processing circuitry 903 (or processing circuitry 1003) performs respective operations of the flow chart. In the description that follows, processing circuitry 903/1003 shall be used to describe operations that the worker role and the master role can perform, processing circuitry 903 shall be used to describe operations that only the worker node/non-leader computing device performs, and processing circuitry 1003 shall be used to describe operations that only the master node/leader computing device performs. As a server computing device and a client computing device may be a worker node or a master node, the term “leader computing device” shall be used to designate a server computing device or a client computing device performing master node tasks and the term “non-leader computing device” shall be used to designate a server computing device or a client computing device performing worker node tasks.

Turning to FIG. 11, a method performed for dynamically configuring a network comprising a plurality of computing devices configured to perform training of a machine learning model, the method performed by a computing device communicatively coupled to the network is provided. For example, the plurality of computing devices may be a set of distributed computing devices (i.e., a plurality of distributed computing devices) for selecting a new leader computing device for operationally controlling a machine learning model, such as a global model, in a telecommunications network.

In block 1101, the processing circuitry 903/1003 may dynamically identify a change in a state of a leader computing device, wherein the leader computing device comprises one of a server computing device and a client computing device and wherein the plurality of computing devices comprise server computing devices and/or client computing devices. In one embodiment, dynamically identifying the change in the state of the leader computing device may include dynamically identifying the change in the state of the leader computing device that affects current performance or future performance of the leader computing device. In other embodiments, dynamically identifying the change in the state of the leader computing device may include detecting at least one of a predicted performance level of the leader computing device, a current performance level of the leader computing device, and a loss in power of a site where the leader computing device is operating.

In some embodiments, the processing circuitry 1003 may dynamically identify the change in the state of the leader computing device based on monitoring conditions of the leader computing device. The monitoring may include monitoring at least one of a predicted performance level of the leader computing device, a current performance level of the leader computing device, and a loss in power at a site where the leader computing device is located. In these embodiments, monitoring the condition of the leader computing device to dynamically identify the change in the state may include monitoring the condition of the leader computing device to detect the change in the state without sharing results of the monitoring to other nodes in the set of distributed nodes.

In yet other embodiments, dynamically identifying the change in the state of the leader computing device may include determining a change in a software version of the leader computing device. For example, an update to the software version may result in a parameter that was being used in the machine learning model (e.g., global model) that was taken out of the software in the update. When this occurs, the leader computing device should withdraw as a leader computing device. Non-leader computing devices that have a software update may also withdraw as participating in the machine learning model.

In further embodiments, dynamically identifying the change in the state of the leader computing device may include determining that the node is operating on battery power. When the leader computing device is operating on battery power, the leader computing device should withdraw from participating in the machine learning system.

In other embodiments, the processing circuitry 903 may dynamically identify the change in the state of the leader computing device by detecting that the leader computing device has not responded to a communication within a period of time.

In another embodiment, the machine learning model may be part of a federated learning system and the processing circuitry 903/1003 may dynamically identify the change in the state of the leader computing device by detecting a change in the state of the leader computing device in the federated learning system that affects current performance or future performance of the leader computing device.

In a further embodiment, the machine learning model may be part of an Internet of things (IoT) learning system. The processing circuitry 903/1003 may dynamically identify the change in the state of the leader computing device by detecting the change in the state of the leader computing device in the IoT learning system that affects current performance or future performance of the leader computing device. The IoT learning system may be one of a massive machine type communication (mMTC) learning system or a critical machine type communication (cMTC) learning system and the processing circuitry 903/1003 may dynamically identify the change in the state of the leader computing device by dynamically identifying the change in the state of the leader computing device in the one of the mMTC learning system or the cMTC learning system that affects current performance or future performance of the leader computing device.

In yet a further embodiment, the machine learning model may be part of a vehicle distributed learning system in a geographic area where the leader computing device is a leader computing device associated with a vehicle, and the processing circuitry 903/1003 may dynamically identifying the change in the state of the leader computing device by detecting that the vehicle is leaving the geographic area. For example, the machine learning model may be for learning road conditions in an area and when the vehicle is leaving the area, the leader computing device associated with the vehicle should withdraw as a leader computing device.

In block 1103, the processing circuitry 903/1003 may determine whether the change in the state of the leader computing device triggers a new leader computing device to be selected. In one embodiment, determining whether the change in the state of the leader computing device triggers a new leader computing device to be selected may include the processing circuitry 1003 determining whether the change in the state of the leader computing device triggers a new leader node to be selected based on at least one performance counter.

The at least one performance counter may be a plurality of performance counters. Turning to FIG. 15, in block 1501, the processing circuitry 1003 may determine whether the change in the state of the leader computing device triggers a new leader computing device to be selected by monitoring the plurality of performance counters of the leader computing device to determine whether a change in at least one of the plurality of performance counters raises above a threshold. Responsive to determining the change raises above the threshold, the processing circuitry 1003 in block 1203 may determine that the change in the state of the leader computing device triggers a new leader computing device to be selected.

In some embodiments, monitoring the plurality of performance counters of the node acting as the leader computing device to determine whether a change in at least one of a plurality of performance counters raises above a threshold comprises monitoring the plurality of performance counters of the node acting as the leader computing device to determine whether a change in a key performance index raises above a key performance index threshold. For example, the key performance index may be a latency key performance index, a reliability key performance index, a throughout key performance index, etc.

In some embodiments, the processing circuitry 903 may, responsive to determining that the leader computing device is not responding to a communication within a period of time, determine that the change in the state of the leader computing device triggers a new leader to be selected.

Returning to FIG. 11, in block 1105, the processing circuitry 903/1003 may initiate a new leader election among the plurality of computing devices responsive to determining the change in the state of the leader computing device triggers the new leader computing device to be selected. In one embodiment, the plurality of computing devices may be a plurality of distributed computing devices.

In block 1107, the processing circuitry 903/1003 may, responsive to initiating the new leader election, transmit, via the network, a leader candidate request message to at least one candidate node that may be the new leader computing device. The leader candidate request message may be transmitted in numerous ways. For example, the processing circuitry 903/1003 may transmit the leader candidate request message to each candidate node of the at least one candidate node to determine nodes that volunteer to be the new leader. This is illustrated in FIGS. 2 and 3. In another embodiment, the processing circuitry 903/1003 may transmit the leader candidate request message to each node of the at least one candidate node that has a higher identification than the node 900/1000. In another embodiment, the processing circuitry 903/1003 may transmit the leader candidate request message using a bully algorithm as described above. In a further embodiment, when the network has a logical ring topology, the processing circuitry 903/1003 may transmit the leader candidate request message using a logical ring topology.

In block 1109, the processing circuitry 903/1003 may receive, via the network, a response from one of the at least one candidate computing device to the leader candidate request message indicating the one of the at least one candidate computing device can be the new leader computing device, wherein receiving the identification of the new leader computing device based on the initiating of the new leader election comprises selecting the new leader computing device based on the response from the one of the at least one candidate computing device.

In block 1111, the processing circuity 903/1003 may transmit, via the network, an acceptance request to the new leader computing device selected. In block 1113, the processing circuitry 903/1003 may receive, via the network, a response from the new leader computing device accepting to be the new leader computing device.

In block 1115, the processing circuity 903/1003 may receive an identification of the new leader computing device based on the initiating of the new leader election. For example, the processing circuitry may receive the identification of the new leader computing device based on the initiating of the new leader node election by selecting the new leader computing device based on the response from the one of the at least one candidate computing device. For example, if only one candidate computing device responded, the candidate node that responded may be selected to be the new leader computing device. If more than one candidate computing device responded, a tie-breaker may be used by the processing circuitry 903/1003 to determine the new leader computing device. For example, the candidate computing device having the highest id may be selected to be the new leader computing device. Other types of tie-breakers may be used. With other leader selection techniques (e.g., the bully algorithm), there is no need for a tie-breaker.

In block 1117, the processing circuitry 903/1003 may update information stored in a distributed ledger responsive to selecting the new leader computing device. The information updated may be the information described above with respect to FIG. 6.

In block 1119, the processing circuitry 1003 may transmit a latest version of the machine learning model (e.g., a global model) to the new leader computing device. In block 1121, the processing circuitry 1003 may, responsive to transmitting the latest version, withdraw the leader computing device 1000 from acting as the leader computing device. The processing circuitry 1003 may continue participating in the machine learning model as a non-leader computing device (e.g., a worker node) responsive to withdrawing as acting as the leader computing device. In an alternative embodiment, the processing circuitry 1003 may withdraw from participating in the machine learning model responsive to withdrawing as acting as the leader computing device.

In some embodiments, the processing circuitry 903/1003 may participate in the new leader election and participate in the machine learning model as one of a non-leader computing device and the new leader computing device. In one embodiment, the current leader computing device may be selected to be the new leader computing device.

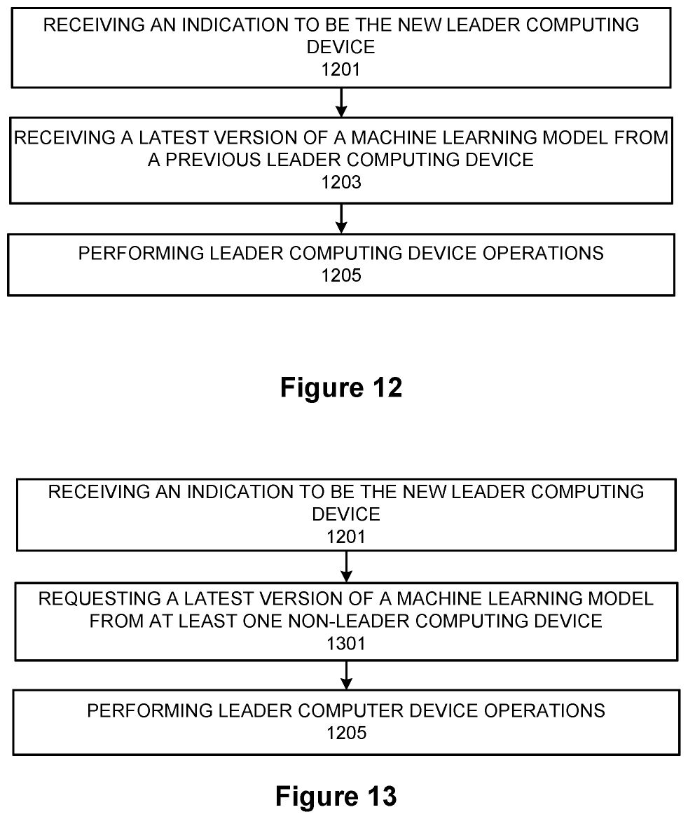

Turning now to FIG. 12, the computing device performing the new leader election may be selected to be the new leader computing device. In block 1201, the processing circuitry 903/1003 may receive an indication to be the new leader computing device. In block 1203, the processing circuitry 903 may receive a latest version of the machine learning model from a current leader computing device. In block 1205, the processing circuitry 903/1003 may perform leader computing device operations.

Turning now to FIG. 13, the current leader computing device may no longer be available. For example, the power at the site where the current leader computing device is located may be down. The processing circuitry 903 performs the same operations in blocks 1301 and 1303 as in FIG. 13. However, in block 1401, the processing circuitry 903 may request a latest version of the machine learning model from at least one non-leader computing device (e.g., a worker node).

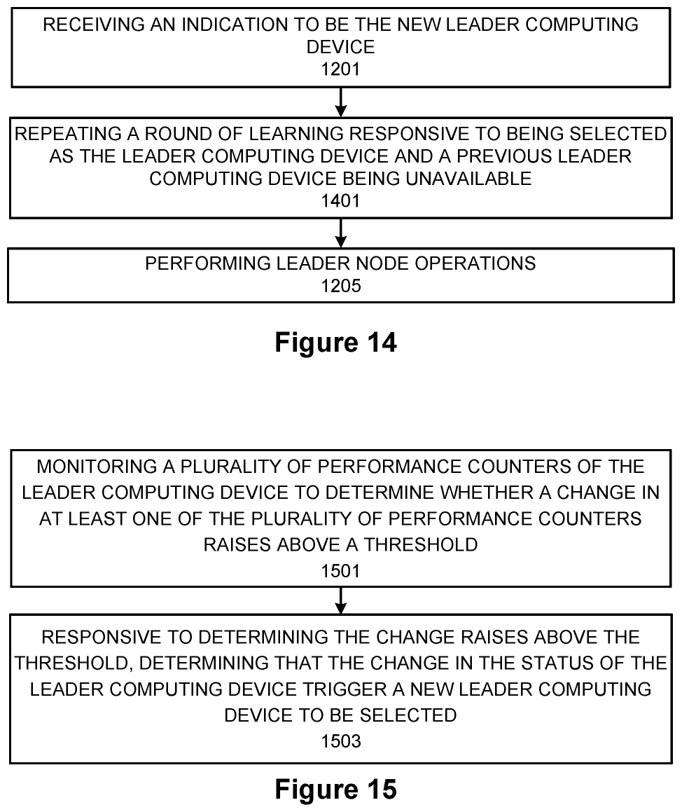

Turning now to FIG. 14, just as in FIG. 13, the current leader node may no longer be available. For example, the power at the site where the current leader node is located may be down. The processing circuitry 903 performs the same operations in blocks 1301 and 1303 as in FIG. 13. In block 1401, the processing circuitry 903 may repeat a round of learning responsive to being selected as the leader node and a previous leader node being unavailable.

In performing leader node operations, the processing circuitry 903/1003 may collect, aggregate, and maintain the machine learning model.

Various operations from the flow chart of FIG. 11 may be optional with respect to some embodiments of worker nodes and master nodes and related methods. For example, operations of blocks 1107, 1109, 1113, 1115, 1117, 1119, and 1121 of FIG. 11 may be optional with respect to independent claims.

Explanations are provided below for various abbreviations/acronyms used in the present disclosure.

| Abbreviation | Explanation |
|---|---|
| ML | Machine Learning |
| FL | Federated Learning |
| eNB | eNodeB |
| cMTC | critical Machine Type Communication |
| mMTC | massive Machine Type Communication |
| v-2-v or V2V | Vehicle to vehicle |
| KPI | Key Performance Indicators |
| RSUs | RoadSide Units |
| URLLC | Ultra-Reliable Low Latency Communications |

References are identified below.
1. H Brendan McMahan, Eider Moore, Daniel Ramage, Seth Hampson, Blaise Agüera y Arcas, “Communication-efficient learning of deep networks from decentralized data”, in Proceedings of the 20th International Conference on Artificial Intelligence and Statistics (AISTATS), 2017. https://arxiv.org/pdf/1602.05629
2. N. Malpani, J. L. Welch, and N. Vaidya, “Leader election algorithms for mobile ad hoc networks,” in Proceedings of the 4th international workshop on Discrete algorithms and methods for mobile computing and communications. ACM, 2000, pp. 96-103

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 16 illustrates a wireless network in accordance with some embodiments where the inventive concepts described above may be used.

Although the subject matter described herein may be implemented in any appropriate type of system using any suitable components, the embodiments disclosed herein are described in relation to a wireless network, such as the example wireless network illustrated in FIG. 16. For simplicity, the wireless network of FIG. 16 only depicts network QQ106, network nodes QQ160 and QQ160b, and WDs QQ110, QQ110b, and QQ110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures.

Network node QQ160 and WD QQ110 comprise various components described in more detail below. These components work together in order to provide network node and/or wireless device functionality, such as providing wireless connections in a wireless network.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 16, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 161 may represent a device that includes the illustrated combination of hardware components, other embodiments may comprise network nodes with different combinations of components.

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160.

Interface QQ190 is used in the wired or wireless communication of signaling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196.

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly.

Antenna QQ162, interface QQ190, and/or processing circuitry QQ170 may be configured to perform any receiving operations and/or certain obtaining operations described herein as being performed by a network node.

Power circuitry QQ187 may comprise, or be coupled to, power management circuitry and is configured to supply the components of network node QQ160 with power for performing the functionality described herein.

Alternative embodiments of network node QQ160 may include additional components beyond those shown in FIG. 16 that may be responsible for providing certain aspects of the network node's functionality, including any of the functionality described herein and/or any functionality necessary to support the subject matter described herein.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. In other embodiments, the interface may comprise different components and/or different combinations of components.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may also in certain embodiments be operable to deliver power from an external power source to power source QQ136. This may be, for example, for the charging of power source QQ136.

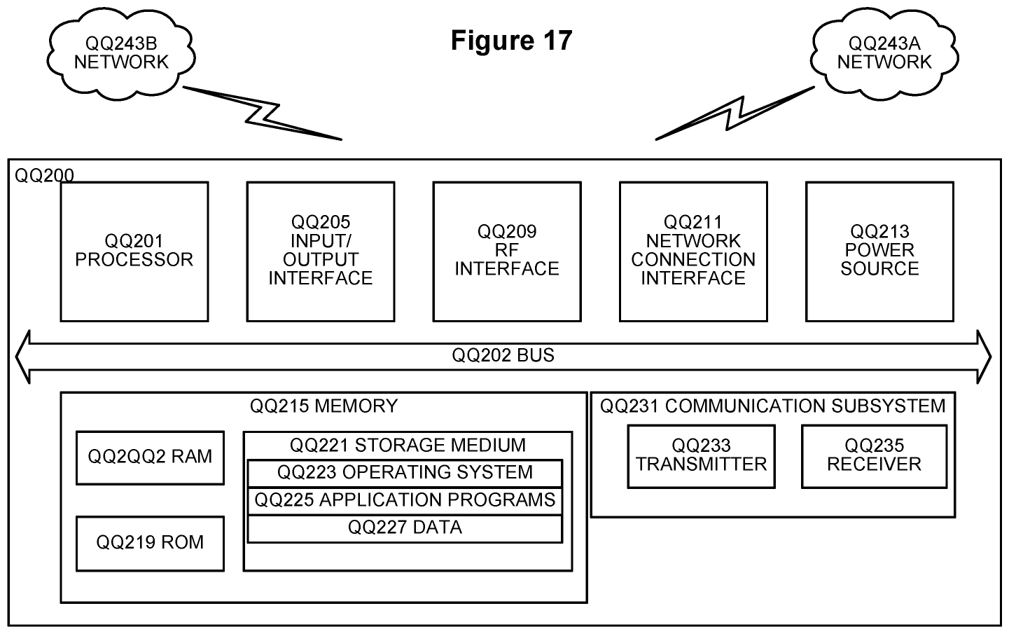

FIG. 17 illustrates a user Equipment in accordance with some embodiments where a leader device and/or a worker node (i.e., a non-leader device) are a user equipment.

FIG. 17 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user. UE QQ2200 may be any UE identified by the 3rd Generation Partnership Project (3GPP), including a NB-IoT UE, a machine type communication (MTC) UE, and/or an enhanced MTC (eMTC) UE. As mentioned previously, the term WD and UE may be used interchangeable. Accordingly, although FIG. 17 is a UE, the components discussed herein are equally applicable to a WD, and vice-versa.

In FIG. 17, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 17, or only a subset of the components. Further, certain UEs may contain multiple instances of a component, such as multiple processors, memories, transceivers, transmitters, receivers, etc.

In FIG. 17, processing circuitry QQ201 may be configured to process computer instructions and data. For example, the processing circuitry QQ201 may include two central processing units (CPUs).

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. UE QQ200 may be configured to use an input device via input/output interface QQ205 to allow a user to capture information into UE QQ200.

In FIG. 17, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. Storage medium QQ221 may store, for use by UE QQ200, any of a variety of various operating systems or combinations of operating systems.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. Further, processing circuitry QQ201 may be configured to communicate with any of such components over bus QQ202. In another example, any of such components may be represented by program instructions stored in memory that when executed by processing circuitry QQ201 perform the corresponding functions described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Abbreviations

At least some of the following abbreviations may be used in this disclosure. If there is an inconsistency between abbreviations, preference should be given to how it is used above. If listed multiple times below, the first listing should be preferred over any subsequent listing(s).

3GPP 3rd Generation Partnership Project

5G 5th Generation

AP Access Point

D2D Device-to-Device

eMTC enhanced Machine Type Communication

gNB Base station in NR

GSM Global System for Mobile communication

LAN Local-Area Network

LTE Long-Term Evolution

M2M Machine-to-Machine

NR New Radio

RAN Radio Access Network

RNC Radio Network Controller

UE User Equipment

V2I Vehicle-to-Infrastructure

WAN Wide-Area Network

WD Wireless Device

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

1. A method for dynamically configuring a network comprising a plurality of computing devices configured to perform training of a machine learning model, the method performed by a computing device communicatively coupled to the network and comprising:
dynamically identifying a change in a state of a leader computing device, wherein the leader computing device comprises one of a server computing device and a client computing device and wherein the plurality of computing devices comprise server computing devices and/or client computing devices;
determining whether the change in the state of the leader computing device triggers a new leader computing device to be selected;
initiating a new leader election among the plurality of computing devices responsive to determining the change in the state of the leader computing device triggers the new leader computing device to be selected; and
receiving an identification of the new leader computing device based on the initiating of the new leader election.

2-24. (canceled)

25. A method performed by a computing device in a plurality of computing devices for selecting a new leader computing device for operationally controlling a machine learning model in a telecommunications network, the method comprising:
dynamically identifying a change in a state of a leader computing device among the plurality of computing devices;
determining whether the change in the state of the leader computing device triggers a new leader computing device to be selected;
initiating a new leader election among the plurality of computing devices responsive to determining the change in the state of the leader computing device triggers a new leader computing device to be selected; and
receiving an identification of the new leader computing device based on the initiating of the new leader election.

26-31. (canceled)

32. A computing device in a network comprising a plurality of computing devices configured to perform training of a machine learning model, wherein the computing device is adapted to perform operations comprising:
dynamically identifying a change in a state of a leader computing device, wherein the leader computing device comprises one of a server computing device and a client computing device and wherein the plurality of computing devices comprise server computing devices and/or client computing devices;
determining whether the change in the state of the leader computing device triggers a new leader computing device to be selected;
initiating a new leader election among the plurality of computing devices responsive to determining the change in the state of the leader computing device triggers a new leader computing device to be selected; and
receiving an identification of the new leader computing device based on the initiating of the new leader election.

33. (canceled)

34. The computing device of any of claims of claim 32, wherein in determining whether the change in the state of the leader computing device triggers a new leader computing device to be selected, the computing device is adapted to perform operations comprising determining whether the change in the state of the leader computing device triggers a new leader computing device to be selected based on at least one performance counter.

35. The computing device of claim 34 wherein the computing device is adapted to perform operations further comprising:
responsive to initiating the new leader election, transmitting a leader candidate request message to each candidate computing device that may be the new leader computing device;
receiving, via the network, a response from at least one candidate computing device to the leader candidate request message indicating the at least one candidate computing device can be the new leader computing device, wherein receiving the identification of the new leader computing device based on the initiating of the new leader election comprises selecting the new leader computing device based on the response from the at least one candidate computing device;
transmitting, via the network, an acceptance request to the new leader computing device selected; and
receiving, via the network, a response from the new leader computing device accepting to be the new leader computing device.

36. The computing device of claim 35 wherein the computing device is the leader computing device, wherein the leader computing device is adapted to perform operations further comprising:
transmitting a latest version of the machine learning model to the new leader computing device; and
responsive to transmitting the latest version, withdrawing from acting as the leader computing device.

37. The computing device of claim 35 wherein the at least one performance counter comprises a plurality of performance counters and determining whether the change in the state of the leader computing device triggers a new leader computing device to be selected comprises:
monitoring the plurality of performance counters of the leader computing device to determine whether a change in at least one of the plurality of performance counters raises above a threshold; and
responsive to determining the change raises above the threshold, determining that the change in the state of the leader computing device triggers a new leader computing device to be selected.

38. The computing device of claim 37 wherein in monitoring the plurality of performance counters of the leader computing device to determine whether a change in at least one of a plurality of performance counters raises above a threshold, the computing device is adapted to perform operations comprising monitoring the plurality of performance counters of the leader computing device to determine whether a change in a key performance index raises above a key performance index threshold.

39. The computing device of claim 32 wherein the machine learning model is part of a federated learning system and in detecting the change in the state of the leader computing device, the computing device is adapted to perform operations comprising detecting the change in the state of the leader computing device in the federated learning system that affects current performance or future performance of the leader computing device.

40-41. (canceled)

42. The computing device of claim 32, wherein the computing device is adapted to perform operations further comprising:
monitoring a condition of the leader computing device to dynamically identify the change in the state of the leader computing device.

43. The computing device of claim 42 wherein in monitoring the condition of the leader computing device to dynamically identify the change in the state of the leader computing device, the computing device is adapted to perform operations comprising monitoring at least one of a predicted performance level of the leader computing device, a current performance level of the leader computing device, and a loss in power at a site where the leader computing device is located.

44. The computing device of claim 42 wherein in monitoring the condition of the leader computing device to dynamically identify the change in the state of the leader computing device, the computing device is adapted to perform operations comprising monitoring the condition of the leader computing device to detect the change in the state of the leader computing device without sharing results of the monitoring to other computing devices in the plurality of computing devices.

45. The computing device of claim 42 wherein in dynamically identifying the change in the state of the leader computing device, the computing device is adapted to perform operations comprising determining a change in a software version of the leader computing device.

46. The computing device of claim 42 wherein in dynamically identifying the change in the state of the leader computing device comprises determining that the leader computing device is operating on battery power and responsive to operating on battery power, withdrawing from participating in the machine learning model.

47. (canceled)

48. The computing device of claim 32, wherein the computing device is adapted to perform operations further comprising:
updating information stored in a distributed ledger responsive to receiving the identification of the new leader computing device.

49. The computing device of claim 32 wherein the machine learning model is part of an Internet of things, IoT, learning system and in dynamically identifying the change in the state of the leader computing device, the computing device is adapted to perform operations comprising detecting the change in the state of the leader computing device in the IoT learning system that affects current performance or future performance of the leader computing device.

50. The computing device of claim 49 wherein the IoT learning system comprises one of a massive machine type communication, mMTC learning system or a critical machine type communication, cMTC, learning system and in dynamically identifying the change in the state of the leader computing device, the computing device is adapted to perform operations comprising dynamically identifying the change in the state of the leader computing device in the one of the mMTC learning system or the cMTC learning system that affects current performance or future performance of the leader computing device.

51. The computing device of claim 32 wherein the machine learning model is part of a vehicle distributed learning system in a geographic area and the leader computing device is a leader computing device associated with a vehicle, and dynamically identifying the change in the state of the leader computing device comprises detecting that the vehicle is leaving the geographic area.

52. (canceled)

53. The computing device of claim 32, wherein the computing device is adapted to perform operations further comprising:
receiving an indication to be the new leader computing device;
receiving a latest version of the machine learning model from a current leader computing device; and
performing leader computing device operations.

54. The computing device of claim 32, wherein the computing device is adapted to perform operations further comprising:
receiving an indication to be the new leader computing device;
requesting a latest version of the machine learning model from at least one non-leader computing device; and
performing leader computing device operations.

55-56. (canceled)
